(19) United States
(12) Patent Application Publication
(10) Pub. No.: US 2011/0146806 A1
(43) Pub. Date: Jun. 23, 2011

(54) Method and device for reducing water friction on the hull of a ship

(76) Inventor: Udo Wulf, Klausdorf/Schwentine (DE)

(21) Appl. No.: 11/596,877

(22) PCT Filed: May 13, 2005
(86) PCT No.: PCT/EP2005/005268

§ 371 Date: Nov. 17, 2006

(30) Foreign Application Priority Data
May 17, 2004 (DE) 10 2004 024 343.3

(51) Int. Cl. F17D 1/16; B63B 1/38

(52) U.S. Cl. 137/13; 114/67 A

(57) ABSTRACT

The invention relates to a method for reducing water friction on the hull of a ship, particularly a canal boat, in which a gas is introduced between the hull and the surrounding water below the water level. The inventive method is characterized in that the gas is introduced into the water in an upper area of the hull close to the water level and that, when the ship is in motion with a resulting water flow along the hull, the introduced gas is guided aftwards into a lower lying area of the hull, particularly below the ship's bottom. The invention also relates to a device for reducing water friction on the hull of a ship.

The invention relates to a method for reducing water friction on the hull of a ship, particularly a canal boat, according to the preamble of claim 1, in which a gas is delivered below the water level between said hull and the water surrounding it in at least one delivery area provided on the hull.

The invention also relates to a device for reducing water friction on the hull of a ship according to the preamble of claim 7, having a means for producing a gas flow on the underbody of the said hull, and at least one delivery area provided on said hull, which is in flow connection with the means and which is constructed for delivering gas between the hull and the water surrounding it.

The introduction of gas, particularly air, on the underbody of a ship hull in order to reduce resistance during the movement of the ship as a result thereof is e.g. known from U.S. Pat. No. 6,145,459. This principle is also known as air lubrication.

U.S. Pat. No. 6,145,459 teaches the introduction of the gas into the surrounding water at the ship's bottom and optionally laterally on the hull. Since on introducing the gas the hydrostatic counterpressure of the surrounding water must be overcome and to this may be added resistance provided by ventilating means, in particular the ship's bottom-side introduction of gas requires a comparatively high gas pressure. Thus, comparatively complicated means are necessary for producing a gas flow, which can lead to increased energy costs.

The object of the invention is to provide a method and a device with which it is possible to effectively reduce in a particularly economic manner water friction on the hull.

According to the invention the object is achieved by a method having the features of claim 1 and a device having the features of claim 7. Preferred embodiments of the invention are given in the dependent claims.

The inventive method for reducing water friction on the hull of a ship is characterized in that the gas is introduced into the water in an upper area of the hull, close to the water level, and that the gas introduced during the movement of the ship is guided with a resulting water flow aftwards along the hull into a lower lying area of said hull and in particular below the ship's bottom.

A fundamental concept of the invention consists of introducing the gas at least partly into the area just below the line of floatation of the ship and in particular bowside, instead of exclusively at the ship's bottom. The water flow at the bow can be used to transport the gas into the depth below the ship's bottom. It has been found that the static counterpressure to be overcome on introducing the gas can be a particularly relevant factor for the efficiency of the method, particularly for an optionally necessary gas flow producing means. Thus, in a type of ship investigated in exemplified manner it has been found that on introducing the gas directly at the ship's bottom in the case of a draught of e.g. 360 cm, an electric fan performance of above 150 kW may be necessary. On introducing the gas directly below the line of floatation said electric fan performance can be reduced to below 40 kW.

The inventive method can fundamentally also be used for the hulls of oceangoing ships. However, the method is particularly appropriate in conjunction with canal boats, especially shallow-draught boats, i.e. those having a relatively limited draught. With such ship types the hull can be constructed in a particularly advantageous manner for the water flow downward transport of the introduced gas.

The gas provided according to the invention can be fundamentally chosen at random. However, a particularly economic method results from the gas being air. A delivery area in the sense of the invention can in particular be such an area on the hull where the gas can be guided through the hull wall from the interior of the hull outwards into the surrounding water. To this end the hull appropriately has introduction openings in the delivery area. These introduction openings can e.g. be constructed as holes in rows. Alternatively or additionally the holes can also be formed in a porous material. Preferably the gas is delivered in the form of bubbles, particularly microbubbles, between the hull and the surrounding water.

The upper area of the hull is, according to the invention, in particular understood to mean an area which is directly below the line of floatation. Appropriately, starting from the water level, the upper area extends by max. 1.5 m and preferably 1 m into the deep. The upper area is preferably a bow area of the ship. The lower lying area in which the gas is guided with the water flow is appropriately in the vicinity of the ship's bottom.

According to a particularly preferred development of the inventive method, the introduced air is guided on a sloping bow into the lower lying area of the hull. It is particularly advantageous for the sloping bow to be constructed in the form of a horizontal wedge. With such a sloping bow shape it is possible to largely prevent the introduced gas from flowing out in the water surface direction laterally with respect to the water flow. A stern and connection area with the preferably largely flat ship's bottom can be connected to the sloping bow.

An advantageous further development of the inventive method comprises the introduced gas being guided between two guide elements or catamaran hulls located externally on the hull into the lower lying area of said hull. Preferably the guide elements are positioned laterally on the wedge-shaped sloping bow. The guide elements e.g. constructed as catamaran hulls can in particular serve to reduce a lateral outflow of the introduced gas in a direction at right angles to the water flow.

According to the invention it is appropriate to introduce the gas into the water in ship's position-dependent manner and in particular draught-dependent manner. This can in particular mean that in the case of a deep-draught ship, i.e. with a high load, the gas is introduced very high on the hull, whereas with a limited draught it is introduced low on the hull and close to the ship's bottom. The height of the upper area on the hull is consequently varied in ship's position-dependent manner, particularly draught-dependent manner. This makes it possible to ensure that the gas is always introduced into the water close to the water level in draught and position-independent manner. For this purpose it is possible to displace the delivery area and in particular a delivery opening heightwise on the hull. However, it is particularly advantageous to determine a geometrical position of the hull, particularly its draught and as a function of the geometrical position at least one delivery area in the upper region of the hull is freed for the gas and further delivery areas at a lower hull level are blocked for the gas. According to this embodiment of the invention there are consequently several delivery areas at different hull heights. With respect to said delivery areas and as a function of the geometrical position, at least the highest delivery area below the present water level, i.e. that closest to the water line is freed for the gas. Optionally for a particularly effective air bubble lubrication it is additionally possible to also free lower lying delivery areas. In order to reduce undesired gas losses, it can be particularly advantageous to block for the gas delivery areas above the water level.

The concept of the geometrical position as a function of which the delivery areas are freed or blocked can in particular be understood to mean the draught of the hull. Alternatively or additionally the geometrical position of the hull can e.g. be characterized by the rolling and/or pitching of the hull and corresponding deflection angles. This makes it possible to ensure according to the invention that also when swell occurs the gas is always delivered directly below the water level. To take account of swell, it is alternatively or additionally possible to have a certain minimum spacing between the freed delivery area and the water level when the ship is stationary.

According to the invention a particularly effective air lubrication can be obtained by introducing the gas into the water in the form of gas bubbles, particularly as a bubble mist.

In order to reduce an undesired enlargement of the gas bubbles when flowing along the hull, at a predetermined distance from the opened delivery area it is possible to at least partly take up the gas bubbles from the water and then to introduce the gas back into the water with a further fan mechanism in order in this way to bring about the starting bubble size. The distance can e.g. be between 4 and 6 m. However, this procedure can be comparatively energy-intensive. Thus, it is particularly preferred by the present invention for the gas bubbles are guided and/or structured along a guide layer, particularly with a thread and/or fibrous material. This guide layer can in particular be constructed in such a way that, whilst largely retaining the bubble size, the said gas bubbles flow in microbubble form along the guide layer or on the surface thereof. For this purpose the guide layer can in particular have fibres and/or threads, whose length is in the range of the desired bubble size or also longer. Preferably the fibres and/or threads also have a colour coating. Structuring in the sense of the invention more particularly means that the gas bubble size is largely retained and/or restored. Through the use of a guide layer for guiding and/or structuring the gas bubbles energy costs for the inventive method can be further reduced.

The device according to the invention is characterized in that the at least one delivery area is located in an upper region of the hull close to a water line thereof on a sloping bow, which when the ship is in motion is constructed for guiding the delivered gas with the water flow aftwards into a lower lying area of the hull.

The inventive device is particularly suitable for performing the inventive method, so that the advantages referred to in this connection are obtained.

A fundamental concept of the inventive device is that the at least one delivery area is not located directly in the lower lying area of the hull, i.e. on the ship's bottom. Instead the at least one delivery area is located close to the water line of the hull, where the gas can be introduced into the water with a comparatively lower power or performance of the gas flow producing means. The at least one delivery area is so positioned on the sloping bow that when the ship is in motion the delivered gas is guided with the water flow along the sloping bow into the lower lying area of the hull and consequently also ensures air lubrication there.

A particularly preferred development of the invention comprises the positioning of the sloping bow between two guide elements or catamaran hulls positioned externally on the hull. The sloping bow can advantageously be constructed in the form of a horizontal web, to which can be connected aft the advantageously flat ship's bottom. Appropriately the underbody is constructed in the manner described in German patent application 103 43 078.

A further preferred development of the invention is characterized in that there are several delivery areas at different heights on the hull and that between the gas flow producing means and the delivery areas there is in each case a valve mechanism for gas flow regulation. This inventive further development in particular makes it possible to supply in draught and/or position-dependent manner gas at least to the delivery area located in the upper region of the hull directly below the water level. However, lower lying delivery areas and/or delivery areas above the water level can be individually blocked for the gas passage by means of the valve mechanism. This ensures a particularly efficient air lubrication. As a result of the individual regulatability of the different delivery areas by the valve mechanisms, it is only necessary to have a single gas flow producing means for supplying all the delivery areas. However, in principle, there can also be several such means, which can be individually controllable.

According to the invention it is also possible to manually operate the valve mechanisms as a function of the ship's draught. However, it is particularly advantageous to provide a control device which is operatively connected to the valve mechanisms for controlling the gas flow as a function of the geometrical position of the hull and in particular its draught. In particular, the control device can automatically determine the position of the ship and for this purpose there can also be a determination of the loading weight. As a result of the inventive control device a particularly reliable inventive device can be obtained.

Another usable development of the invention is characterized in that the at least one delivery area is constructed for the delivery of gas in the form of gas bubbles and in particular in porous manner. The delivery area can in particular be flat and have a spray body, which e.g. has a porous plastics material and/or a porous ceramic material.

A particularly appropriate embodiment of the invention comprises providing on the underbody of the hull, particularly on the sloping bow, a guide layer, particularly a fibrous layer, for guiding and/or structuring the gas bubbles. The guide layer can e.g. be embedded in the hull and/or bonded thereto. Appropriately the guide layer has individual layer strips arranged on the hull at right angles to the direction of travel. Appropriately the distance between the individual layer strips is roughly 2 to 8 m, particularly 4 to 6 m.

It is also particularly advantageous for the gas flow producing means to have at least one fan or blower. The latter is advantageously connected to the delivery areas by means of a line system located in the interior of the hull, the valve mechanisms then being positionable on the line system.

The invention is described in greater detail hereinafter relative to preferred embodiments and the attached diagrammatic drawings, wherein show:

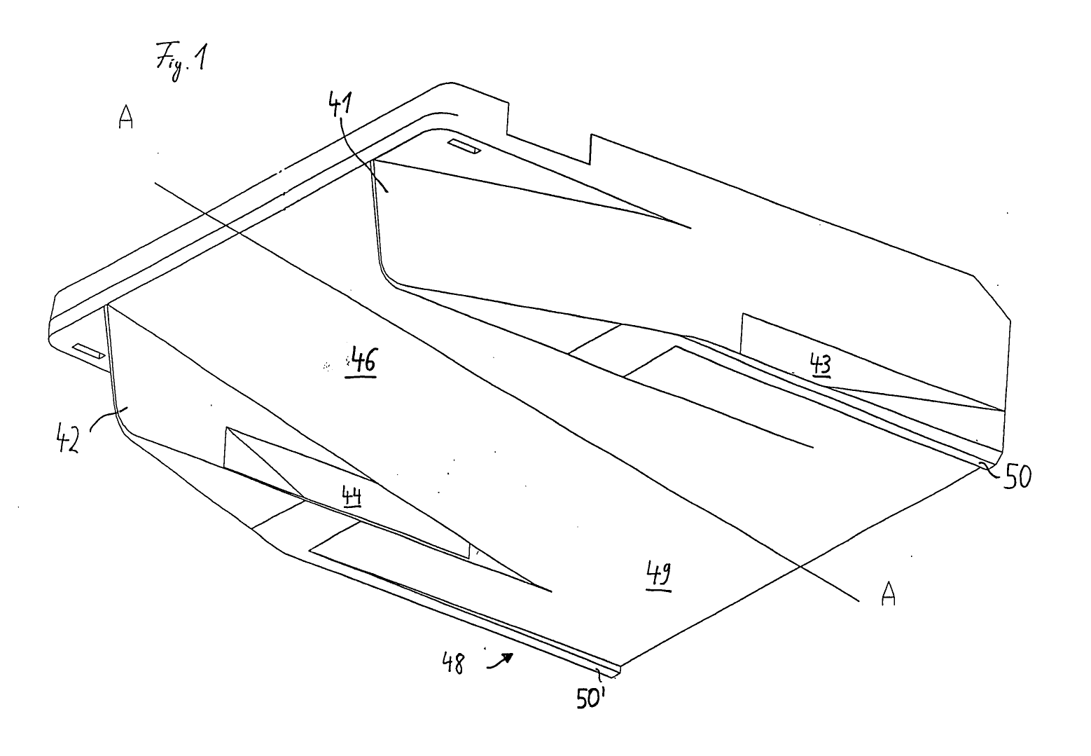

FIG. 1A perspective view of the underbody of a hull for performing the inventive method.

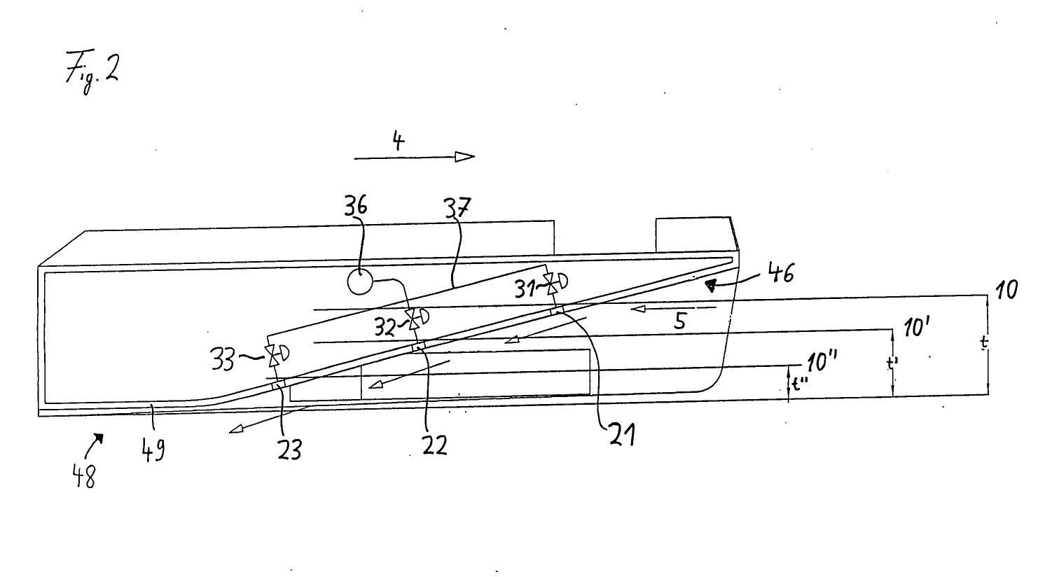

FIG. 2 A longitudinal section along A-A of the hull in FIG. 1 with an inventive device for performing the inventive method for differing draughts.

A hull for implementing the method according to the invention is shown in FIGS. 1 and 2 in the sense of a bow module. The hull is constructed in semi-catamaran manner and has a sloping bow 46, a catamaran hull 41, 42 being provided on both the starboard side and the portside thereof. In their bow area the catamaran hulls 41, 42 are constructed in the form of vertical wedges. However, the sloping bow 46 is constructed in the form of a horizontal wedge. The catamaran hulls 41, 42 contain recesses 43, 44 for receiving drive means. Starting from the sloping bow 46, the recesses 43, 44 slope aft through the catamaran hulls 41, 42 to the outside of the hull.

The bow module with sloping bow 46 is provided aft with a box-like stern area 48 with a substantially flat ship's bottom 49, to which can be connected one or more, e.g. pontoon-like hull modules. On both the port and starboard sides on stern area 48 and in the extension of the catamaran hulls 41, 42 are provided guide elements 50, 50′, which project downwards from and laterally bound the ship's bottom 49.

An inventive device for performing the inventive method is shown in FIG. 2, which is a sectional view along A-A of the hull in FIG. 1 for different draughts t, t′, t″ as a result of a different loading weight of the ship. The water level is in each case indicated by the references 10, 10′, 10″, which as a result of the different submergence depth also corresponds to the water line on the hull.

The inventive device has a gas flow producing means 36 in the form of a fan or blower. Means 36 is connected by means of a line system 37 to three spatially separated delivery areas 21, 22, 23, which are provided at different hull heights in the wall of the sloping bow 46. Through said delivery areas 21, 22, 23 gas, particularly air, can be introduced into the water surrounding the hull. For individually regulating the gas flow through the individual delivery areas 21, 22, 23, upstream of each of the latter is in each case provided in line system 37 a valve mechanism 31, 32, 33.

During the operation of the inventive device the valve mechanisms 31, 32, 33 are set in such a way that gas always only passes out of the delivery area directly below the given water level 10, 10′, 10″. In contrast, valve mechanisms 32, 33 block the remaining delivery areas, e.g. 22, 23. With the draught t consequently only delivery area 21, at draught t′ only delivery area 22 and at draught t″ only delivery area 23 is freed for the gas flow.

When the ship travels in direction 4, below the sloping bow 46 there is a water flow illustrated by arrows 5 in FIG. 2 for draught t. Said water flow guides the gas passing out of delivery area 21 in bubble form between the catamaran hulls 41, 42 downwards along the sloping bow 46 and aftwards below the ship's bottom 49 to stern area 48. A lateral outflow of the gas at ship's bottom 49 is largely prevented by guide elements 50, 50′.

1-13. (canceled)

14. A method for reducing water friction on the hull of a ship in which
by means of at least one delivery area provided on the hull a gas is delivered below water level in the form of gas bubbles between the said hull and the water surrounding it,
wherein
the gas is introduced into the water close to water level in an upper area of the hull,
from where, when the ship is in motion with a resulting water flow, it is guided between two guide elements or catamaran hulls positioned externally on the hull along the latter aftwards into a lower lying area of the hull.

15. The method according to claim 14, wherein the introduced gas is guided on a sloping bow into the lower lying area of the hull.

16. The method according to claim 14, wherein a geometrical position of the hull is determined and
as a function of the geometrical position at least one delivery area in the upper region of the hull is freed for the gas and further delivery areas at other hull heights are blocked for the gas.

17. The method according to claim 16, wherein the geometrical position of the hull is its draught.

18. The method according to claim 14, wherein the gas is introduced into the water in bubble mist form.

19. The method according to claim 14, wherein the gas bubbles are guided and/or structured along a guide layer on the underbody of the hull.

20. The method according to claim 19, wherein the guide layer has a fibrous material or a thread material.

21. The method according to claim 14, wherein when the ship is in motion with a resulting water flow, the gas is guided between the two guide elements or catamaran hulls positioned externally on the hull along the latter aftwards below the ship's bottom.

22. The method according to claim 14, wherein the ship is a canal boat.

23. A device for reducing water friction on the hull of a ship comprising:
means for producing a gas flow on the underbody of the hull and
at least one delivery area provided on the hull and which is in flow connection with the means and which is constructed for delivering gas between the hull and the surrounding water in the form of gas bubbles,
wherein
the at least one delivery area is located in an upper area of the hull close to the water line thereof on a sloping bow located between two guide elements or catamaran hulls located externally on the hull, which sloping bow is constructed for guiding the delivered gas when the ship is in motion aftwards with the water flow into a lower lying area of the hull.

24. The device according to claim 23, wherein
there are several delivery areas at different hull heights and
between the gas flow producing means and the delivery areas there is in each case a valve mechanism for gas flow regulation.

25. The device according to claim 24, wherein a control device is provided and is in operative connection with the valve mechanism for controlling the gas flow as a function of a geometrical position of the hull.

26. The device according to claim 25, wherein the geometrical position of the hull is its draught.

27. The device according to claim 23, wherein the at least one delivery area is porous.

28. The device according to claim 23, wherein on the underbody of the hull there is a guide layer for guiding and/or structuring the gas bubbles.

29. The device according to claim 28, wherein the guide layer is provided on the sloping bow.

30. The device according to claim 28, wherein the guide layer is a fibrous layer.

31. The device according to claim 23, wherein the gas flow producing means has at least one fan.

32. The device according to claim 23, wherein it is designed for performing a method for reducing water friction on the hull of a ship in which
by means of at least one delivery area provided on the hull a gas is delivered below water level in the form of gas bubbles between the said hull and the water surrounding it,
wherein
the gas is introduced into the water close to water level in an upper area of the hull,
from where, when the ship is in motion with a resulting water flow, it is guided between two guide elements or catamaran hulls positioned externally on the hull along the latter aftwards into a lower lying area of the hull.
